(19) United States
(12) Patent Application Publication
(10) Pub. No.: US 2018/0358679 A1
(43) Pub. Date: Dec. 13, 2018

(54) FEED CIRCUIT AND ANTENNA APPARATUS

(71) Applicant: MITSUBISHI ELECTRIC CORPORATION, Tokyo (JP)

(72) Inventors: Hidenori YUKAWA, Tokyo (JP); Yu USHIJIMA, Tokyo (JP); Motomi WATANABE, Tokyo (JP); Naofumi YONEDA, Tokyo (JP)

(73) Assignee: MITSUBISHI ELECTRIC CORPORATION, Tokyo (JP)

(21) Appl. No.: 16/060,237

(22) PCT Filed: Jan. 12, 2016
(86) PCT No.: PCT/JP2016/050672

§ 371 Date: Jun. 7, 2018

(51) Int. Cl. H01P 5/12; H01P 5/20; H01P 1/17; H01Q 25/00; H01P 5/02

(52) U.S. Cl. CPC H01P 5/20; H01P 5/02; H01Q 25/00; H01P 1/17

(57) ABSTRACT

A third coupler (3c) outputs a signal outputted from a first coupler (3a) to an input terminal (8-1) of a second septum polarizer (8b), and outputs a signal outputted from a second coupler (3b) to an input terminal (8-2) of a first septum polarizer (8a).

### TECHNICAL FIELD

The present disclosure relates to a feed circuit for multibeam antennas for use mainly in a VHF (Very High Frequency) band, a UHF (Ultra High Frequency) band, a microwave band, or a millimeter wave band, and antenna apparatus provided with the feed circuit.

### BACKGROUND ART

In Nonpatent Literature 1, an antenna system for multibeam antennas for use in satellite communications is described. The antenna system includes a reflector antenna and plural radiating elements, and plural beams radiated from the plural radiating elements are reflected by the reflector antenna to form one or more multibeams. A signal is distributed to the radiating elements with a predetermined excitation amplitude and a predetermined excitation phase by the feed circuit, and each of the radiating elements radiates a beam.

A feed circuit includes, for example, septum polarizers, terminators, and couplers, and these components are typically fabricated using waveguides.

Each septum polarizer has a first input terminal, a second input terminal and an output terminal, and a radiating element is connected to each output terminal. Septum polarizers output a circularly polarized signal with a rotation direction which differs between when a signal is inputted to the first input terminal and when a signal is inputted to the second input terminal.

For example, a septum polarizer outputs a left-hand circularly polarized signal from the output terminal when a signal is inputted to the first input terminal, or outputs a right-hand circularly polarized signal from the output terminal when a signal is inputted to the second input terminal.

Each terminator terminates an input terminal on the same side of a septum polarizer disposed for each radiating element. For example, in a case in which a first input terminal of one septum polarizer is terminated by a terminator, a first input terminal of another septum polarizer which is an input terminal on the same side is terminated.

Each coupler has four terminals, and two of these terminals are connected to the two input terminals of a septum polarizer disposed for each radiating element, respectively.

Further, in each coupler, a signal inputted from one terminal is outputted from two terminals, and the ratio of amplitudes of output signals is determined by a designed degree of coupling. The phase difference between the output signals is 90 degrees.

A terminal other than the terminals related to input and output, among the four terminals which each coupler has, serves as an isolation terminal, and no signal is outputted from this terminal.

In the above-mentioned feed circuit, a signal from each coupler is inputted to the input terminal on the same side of a septum polarizer disposed for each radiating element. As a result, when one of adjacent multibeams is outputted and when the other one of the adjacent multibeams is outputted, beams radiated from two radiating elements which are shared between these multibeams are circularly polarized waves having the same rotation direction.

### CITATION LIST

### Patent Literature

Non Patent Literature 1: P. Angeletti, M. Lisi, “Multimode Beamforming Networks”, ESA, Antennas and Propagation Magazine, IEEE, 2014.

### SUMMARY OF INVENTION

### Technical Problem

There is a situation in which a circularly polarized beam with a rotation direction which differs between when one of adjacent multibeams is outputted and when the other one of the adjacent multibeams is outputted is used in a portion in which these multibeams overlap each other. In this case, it is necessary to dispose a feed circuit that inputs signals to different input terminals of each of two septum polarizers respectively connected to two radiating elements which are shared between adjacent multibeams.

In a conventional antenna apparatus, a feed circuit in which a connecting line via which a signal from a coupler is inputted to a first input terminal of one septum polarizer, and a connecting line via which the signal from another coupler is inputted to a second input terminal of another septum polarizer are disposed is adopted. By disposing these connecting lines, signals can be inputted from couplers to different input terminals of each of the septum polarizers, and circularly polarized beams with different rotation directions can be radiated from the radiating elements connected to the septum polarizers.

However, since in the above-mentioned feed circuit the above-mentioned two connecting lines cross each other, it is necessary to arrange the connecting lines in such a way that one of the connecting lines is caused to detour around the other connecting line.

Therefore, a problem is that an arrangement of the connecting lines is complicated, resulting in a complicated circuit configuration of a feed circuit.

Embodiments of the present disclosure is made in order to solve the above-mentioned problem, and it is therefore an object of the present disclosure to provide a feed circuit that can use polarized beams having different directions in a portion in which multibeams overlap each other, with a simple circuit configuration, and an antenna apparatus provided with this feed circuit.

### Solution to Problem

According to the present disclosure, there is provided a feed circuit including a first polarizer, a second polarizer, a first two-way distributor, a second two-way distributor, and a third coupler.

Each of the first and second polarizers has an output terminal and two input terminals, and outputs, from the output terminal thereof, a signal having polarization whose direction differs between when a signal is inputted to one of the two input terminals thereof and when a signal is inputted to the other one of the input terminals thereof.

The first two-way distributor has two terminals via each of which a signal is inputted or outputted, one of the two terminals thereof being connected to the one of the input terminals of the first polarizer, and distributes an input signal to the two terminals thereof and outputs two signals.

The second two-way distributor has two terminals via each of which a signal is inputted or outputted, one of the two terminals thereof being connected to the other one of the input terminals of the second polarizer, and distributes an input signal to the two terminals thereof and outputs two signals.

The third coupler outputs a signal outputted from the other one of the two terminals of the first two-way distributor to the one of the input terminals of the second polarizer, and outputs a signal outputted from the other one of the two terminals of the second two-way distributor to the other one of the input terminals of the first polarizer.

### Advantageous Effects of Invention

According to the present disclosure, the third coupler outputs a signal outputted from the first two-way distributor to the one of the input terminals of the second polarizer, and outputs a signal outputted from the second two-way distributor to the other one of the input terminals of the first polarizer. As a result, because the connecting lines connecting the two-way distributors and the polarizers do not cross each other, and it is not necessary to cause one of the connecting lines to detour around the other connecting line, the feed circuit can be implemented with a simple circuit configuration. Further, because it is possible to input a signal to one of the input terminals of each of the polarizers, the one being different between when one of adjacent multibeams is radiated and when the other multibeam is radiated, polarized beams having different directions can be used in a portion in which these multibeams overlap each other.

### BRIEF DESCRIPTION OF DRAWINGS

FIG. 1A is a block diagram showing an overview of the configuration of an antenna apparatus according to the present disclosure, and FIG. 1B is a diagram showing an overview of antenna beams formed by the antenna apparatus shown in FIG. 1A;

FIG. 2A is a block diagram showing the configuration of a feed circuit according to Embodiment 1, and FIG. 2B is a block diagram showing the configuration of a conventional feed circuit;

FIG. 3A is a diagram showing a first coupler and a second coupler, and FIG. 3B is a diagram showing an overview of signal splitting performed by each of the first and second couplers;

FIG. 4A is the diagram showing a third coupler, and FIG. 4B is a diagram showing an overview of signal splitting performed by the third coupler.

FIG. 5A is a diagram showing a first septum polarizer and a second septum polarizer, and FIG. 5B is a diagram showing an overview of output of a circularly polarized wave which is performed by each of the first and second septum polarizers;

FIG. 6 is a block diagram showing another example of the configuration of the feed circuit according to Embodiment 1;

FIG. 7 is a block diagram showing the configuration of a feed circuit according to Embodiment 2 of the present disclosure;

FIG. 8 is a top view showing the configuration of waveguides of the feed circuit according to Embodiment 2;

FIG. 9 is a perspective view showing the configuration of a waveguide of each of first and second couplers;

FIG. 10 is a perspective view showing the configuration of a waveguide of each of first and second septum polarizers;

FIG. 11 is a block diagram showing the configuration of a feed circuit according to Embodiment 3 of the present disclosure;

FIG. 12 is a top view showing the configuration of waveguides of the feed circuit according to Embodiment 3;

FIG. 13 is a perspective view showing the configuration of a waveguide of each of first and second T-branching circuits; and

FIG. 14 is a top view showing another example of the configuration of waveguides of the feed circuit according to Embodiment 3.

### DESCRIPTION OF EMBODIMENTS

Hereafter, in order to explain this disclosure in greater detail, embodiments according to the present disclosure will be described with reference to the accompanying drawings.

### Embodiment 1

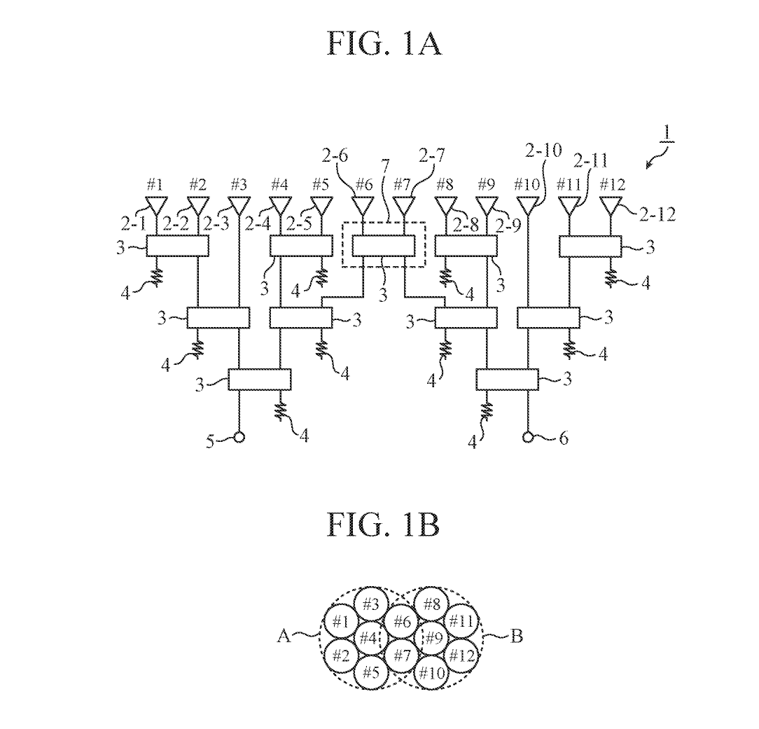

FIG. 1A is a block diagram showing an overview of the configuration of an antenna apparatus 1 according to the present disclosure. Further, FIG. 1B is a diagram showing an overview of antenna beams formed by the antenna apparatus 1 shown in FIG. 1A. The antenna apparatus 1 includes radiating elements 2-1 to 2-12 and feed circuitry, and beams radiated from the radiating elements 2-1 to 2-12 are reflected by a not-illustrated reflector antenna and are emitted as multibeams, and a beam reflected by the above-mentioned reflector antenna is received.

The feed circuitry distributes a signal to the radiating elements 2-1 to 2-12 with a predetermined excitation amplitude and a predetermined excitation phase, and includes plural couplers 3, plural terminators 4, an input terminal 5, and an input terminal 6. Each of these components is typically fabricated using a waveguide.

Although not illustrated in FIG. 1A, the antenna apparatus 1 includes one or more phase shift circuits. In order to implement a desired phase shift distribution in the radiating elements, a phase difference of 90 degrees of the signal outputted from the feed circuitry is corrected using a phase shift amount of the one or more phase shift circuits.

Each of the terminators 4 is connected to an isolation terminal of a coupler 3. As a result, in each of the couplers 3, an input signal is outputted from distribution terminals thereof without leaking to an isolation terminal thereof.

A signal inputted to the input terminal 5 is distributed in sequence by couplers 3. When this signal is then distributed to the radiating elements 2-1 to 2-7, beams #1 to #7 are radiated from the radiating elements 2-1 to 2-7 to form a multibeam A.

Likewise, a signal inputted to the input terminal 6 is also distributed in sequence by couplers 3. When this signal is then distributed to the radiating elements 2-6 to 2-12, beams #6 to #12 are radiated from the radiating elements 2-6 to 2-12 to form a multibeam B.

In addition to the couplers 3, the terminators 4, and the input terminals 5 and 6 described in FIG. 1A as the components of the feed circuitry, septum polarizers are added to the components of the feed circuitry in a case in which a circularly polarized beam is caused to be radiated from the radiating elements.

For example, the multibeams A and B overlap each other with the radiating elements 2-6 and 2-7 being shared. In a case in which as the multibeams A and B, circularly polarized beams having rotation directions different from each other are provided, a septum polarizer is disposed between each of the radiating elements 2-1 to 2-12 and the coupler 3 connected to this radiating element in the configuration shown in FIG. 1A. In this case, a septum polarizer is disposed also in a feed circuit 7 according to Embodiment 1 which is shown in FIGS. 1A and 1s enclosed by a broken chain line.

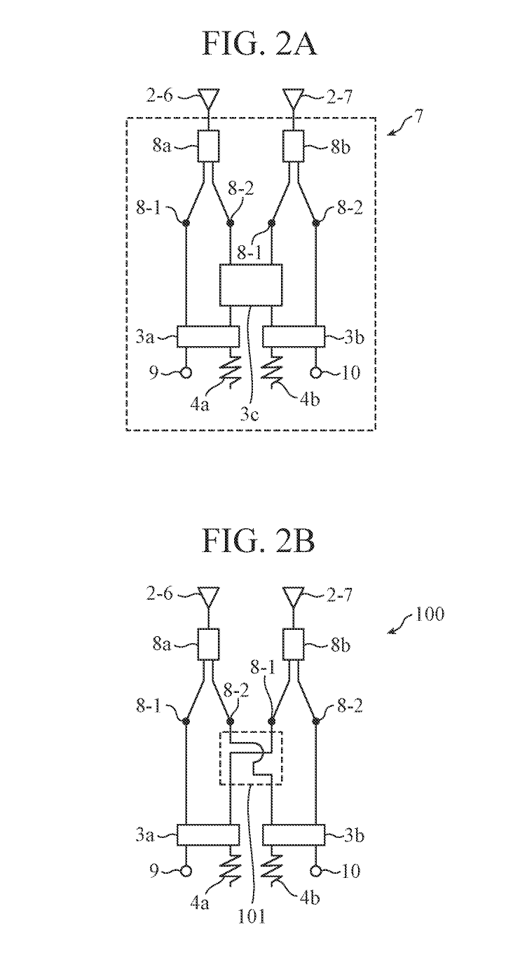

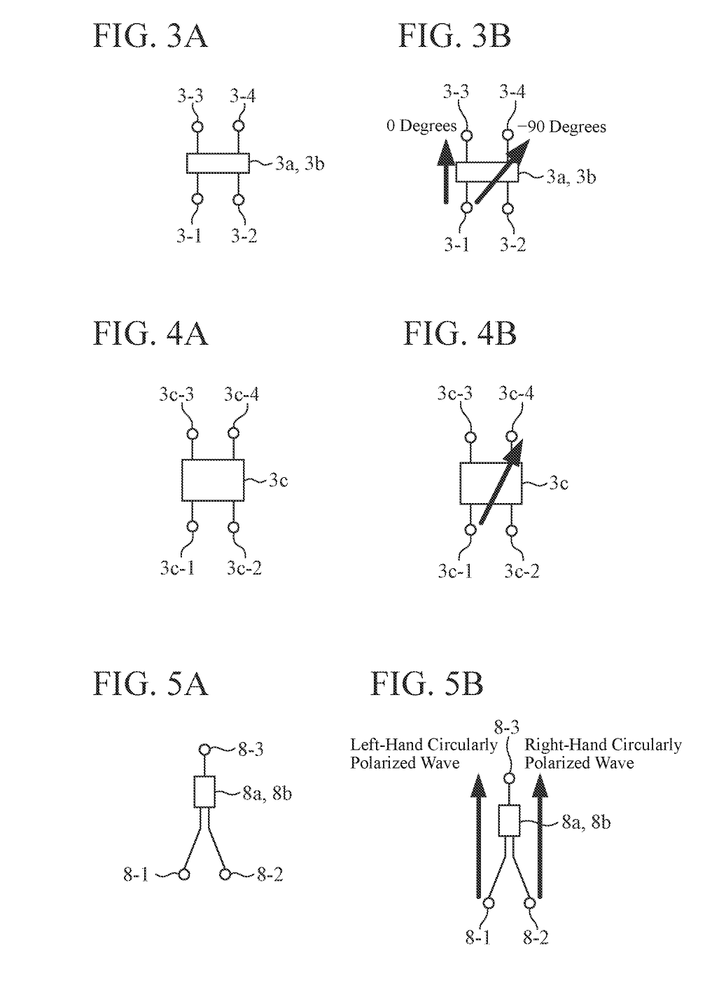

FIG. 2A is a block diagram showing the configuration of the feed circuit 7 according to Embodiment 1, and the feed circuit 7 is described together with the radiating elements 2-6 and 2-7. FIG. 2B is a block diagram showing the configuration of a conventional feed circuit 100. FIG. 3A is a diagram showing each of first and second couplers 3a and 3b, and FIG. 3B is a diagram showing an overview of signal distribution performed by each of the first and second couplers 3a and 3b. FIG. 4A is a diagram showing a third coupler 3c, and FIG. 4B is a diagram showing an overview of signal distribution performed by the third coupler 3c. FIG. 5A is a diagram showing each of first and second septum polarizers 8a and 8b. FIG. 5B is a diagram showing an overview of output of a circularly polarized wave which is performed by each of the first and second septum polarizers 8a and 8b.

The feed circuit 7 causes each of the radiating elements 2-6 and 2-7 to radiate a circularly polarized beam with a rotation direction which differs between when the multibeam A is outputted and when the multibeam B is outputted. As components of the feed circuit, as shown in FIG. 2A, a first coupler 3a having an input terminal 9, a second coupler 3b having an input terminal 10, a third coupler 3c, a terminator 4a, a terminator 4b, a first septum polarizer 8a, and a second septum polarizer 8b are included.

The radiating elements 2-6 and 2-7 radiate the beams #6 and #7 in a portion in which the multibeams A and B overlap each other, as shown in FIG. 1A.

The first coupler 3a and the second coupler 3b are concrete examples of a first two-way distributor and a second two-way distributor according to the present disclosure, and each of the couplers 3a and 3b is embodied as, for example, a 3 dB coupler. A 3 dB coupler distributes a signal inputted from one terminal thereof to two terminals thereof and outputs two signals.

Each of the first and second couplers 3a and 3b has four terminals 3-1 to 3-4, as shown in FIG. 3A, and distributes a signal inputted to one of these terminals to two of the remaining three terminals and outputs two signals.

For example, a signal inputted to the terminal 3-1 is distributed to the two terminals 3-3 and 3-4 and two signals are outputted, as shown using arrows in FIG. 3B. The ratio of amplitudes of the signals outputted is decided in accordance with a designed degree of coupling, and the phase difference between the signals is 90 degrees.

A terminal which is not related to the input and the output serves as an isolation terminal, and no signal is outputted from the isolation terminal.

Further, the terminal 3-1 of the first coupler 3a is connected to the input terminal 9 shown in FIG. 2A. The input terminal 9 serves as an input terminal to which a signal for forming the multibeam A is inputted.

The terminator 4a is connected to the terminal 3-2 of the first coupler 3a, and no signal is outputted from the terminal 3-2.

The terminal 3-3 of the first coupler 3a serves as a distribution terminal to which a signal inputted to the input terminal 9 is distributed, and is connected to the input terminal 8-1 of the first septum polarizer 8a.

The terminal 3-4 of the first coupler 3a serves as a distribution terminal to which a signal inputted to the input terminal 9 is distributed, like the terminal 3-3, and is connected to the terminal 3c-1 of the third coupler 3c.

The terminator 4b is connected to the terminal 3-1 of the second coupler 3b, and no signal is outputted from this terminal 3-1. Further, the terminal 3-2 of the second coupler 3b is connected to the input terminal 10 shown in FIG. 2A. The input terminal 10 serves as an input terminal to which a signal for forming the multibeam B is inputted.

The terminal 3-3 of the second coupler 3b serves as a distribution terminal to which a signal inputted to the input terminal 10 is distributed, and is connected to the terminal 3c-2 of the third coupler 3c.

The terminal 3-4 of the second coupler 3b serves as a distribution terminal to which a signal inputted to the input terminal 10 is distributed, and is connected to the input terminal 8-2 of the second septum polarizer 8b.

The third coupler 3c may be, for example, a 0 dB coupler, and has four terminals 3c-1 to 3c-4, as shown in FIG. 4A. A 0 dB coupler provides coupling between an input thereof and an output thereof with an insertion loss of approximately 0 dB.

A signal inputted to the terminal 3c-1 is outputted from the terminal 3c-4 which is positioned diagonally with respect to the terminal 3c-1, as shown by an arrow in FIG. 4B. More specifically, the terminal 3c-4 serves as a distribution terminal to which a signal inputted to the terminal 3c-1 is distributed.

Likewise, since a signal inputted to the terminal 3c-2 is outputted from the terminal 3c-3, the terminal 3c-3 serves as a distribution terminal to which a signal inputted to the terminal 3c-2 is distributed.

The terminal 3c-1 of the third coupler 3c is connected to the terminal 3-4 of the first coupler 3a, and the terminal 3c-2 of the third coupler 3c is connected to the terminal 3-3 of the second coupler 3b, as mentioned above. Further, the terminal 3c-3 of the third coupler 3c is connected to the input terminal 8-2 of the first septum polarizer 8a, and the terminal 3c-4 of the third coupler 3c is connected to the input terminal 8-1 of the second septum polarizer 8b, as shown in FIG. 2A.

The coupler 3 of the feed circuit 7 shown in FIG. 1A includes the first, second, and third couplers 3a, 3b, and 3c.

The first septum polarizer 8a and the second septum polarizer 8b are concrete examples of a first polarizer and a second polarizer according to the present disclosure, and each of the septum polarizers has the two input terminals 8-1 and 8-2 and an output terminal 8-3, as shown in FIG. 5A.

The radiating element 2-6 is connected to the output terminal 8-3 of the first septum polarizer 8a, and the radiating element 2-7 is connected to the output terminal 8-3 of the second septum polarizer 8b, as shown in FIG. 2A.

Further, each of the first and second septum polarizers 8a and 8b outputs, from the output terminal 8-3 thereof, a circularly polarized signal with a rotation direction which differs between when a signal is inputted to the input terminal 8-1 thereof and when a signal is inputted to the input terminal 8-2 thereof, as shown in FIG. 5B.

In FIG. 5B, a case in which when a signal is inputted to the input terminal 8-1, a left-hand circularly polarized signal is outputted from the output terminal 8-3, and when a signal is inputted to the input terminal 8-2, a right-hand circularly polarized signal is outputted from the output terminal 8-3 is shown.

In the following explanation, it is assumed that in each of the septum polarizers, a signal having circular polarization is outputted in accordance with the relation shown in FIG. 5B. Note that, FIG. 5B shows an example of each of the septum polarizers.

More specifically, in the present disclosure, polarizers in each of which a right-hand circularly polarized signal is outputted when a signal is inputted to the input terminal 8-1, and a left-hand circularly polarized signal is outputted when a signal is inputted to the input terminal 8-2 can be alternatively used.

As shown in FIG. 2B, in the conventional feed circuit 100, a terminal 3-4 of a first coupler 3a and an input terminal 8-1 of a second septum polarizer 8b are connected directly to each other via a line, and a terminal 3-3 of a second coupler 3b and an input terminal 8-2 of a first septum polarizer 8a are connected directly to each other via a line. Therefore, in these connecting lines, there exists a crossover 101 which is shown in FIG. 2B and is enclosed by a broken chain line.

In this crossover 101, one of the connecting lines needs to be caused to cross the other connecting line in an electrically non-contact state, and, for example, one of the connecting lines is arranged so as to detour around the other connecting line via a bridge conductor, conductor layers different from each other, or the like. Further, in a case in which the connecting lines are implemented using waveguides, the waveguides have a complicated configuration in which one of the waveguides is caused to detour around the other waveguide.

Therefore, a problem is that the connecting lines in the crossover 101 is complicated, resulting in a complicated circuit configuration of the feed circuit 100.

In contrast with this, in the feed circuit 7 according to the present disclosure, the couplers and the septum polarizers are not directly connected to each other via lines, but are connected to each other via the third coupler 3c. The third coupler 3c outputs a signal outputted from the first coupler 3a to the input terminal 8-1 of the second septum polarizer 8b, and outputs a signal outputted from the second coupler 3b to the input terminal 8-2 of the first septum polarizer 8a. As a result, since the connecting lines connecting the couplers and the septum polarizers do not cross each other, and it is not necessary to cause one of the connecting lines to detour around the other connecting line, the feed circuit 7 can be implemented with a simple circuit configuration in which, for example, the couplers and the septum polarizers are arranged on a planar substrate.

Next, operations will be explained.

Hereafter, a case of radiating left-hand circularly polarized beams as the multibeam A, and radiating right-hand circularly polarized beams as the multibeam B will be mentioned as an example.

First, when a signal for forming the multibeam A is inputted to the input terminal 5 shown in FIG. 1A, this signal is distributed in sequence by couplers 3 and is outputted to the couplers 3 connected to the radiating elements 2-1 to 2-7. At this time, when the signal is inputted to the input terminal 9 of the feed circuit 7, the first coupler 3a distributes this signal to the two terminals 3-3 and 3-4 thereof and outputs two signals.

The signal outputted from the terminal 3-3 of the first coupler 3a is inputted to the input terminal 8-1 of the first septum polarizer 8a, and is converted into a left-hand circularly polarized signal by the first septum polarizer 8a and this left-hand circularly polarized signal is outputted from the output terminal 8-3. As a result, the radiating element 2-6 radiates a left-hand circularly polarized beam #6.

The signal outputted from the terminal 3-4 of the first coupler 3a is inputted to the input terminal 8-1 of the second septum polarizer 8b by the third coupler 3c.

The second septum polarizer 8b converts the signal inputted from the third coupler 3c into a left-hand circularly polarized signal, and outputs this left-hand circularly polarized signal from the output terminal 8-3 thereof. As a result, the radiating element 2-7 radiates a left-hand circularly polarized beam #7.

Further, also in feed circuits for supplying electric power to the radiating elements 2-1 to 2-5, left-hand circularly polarized signals are outputted to the radiating elements 2-1 to 2-5 by septum polarizers. As a result, beams #1 to #5 radiated from the radiating elements 2-1 to 2-5 are also left-hand circularly polarized beams.

In this way, the multibeam A including the beams #6 and #7 is left-hand circularly polarized beams.

Further, when a signal for forming the multibeam B is inputted to the input terminal 6 shown in FIG. 1A, this signal is distributed in sequence by couplers 3 and is outputted to the couplers 3 connected to the radiating elements 2-6 to 2-12. At this time, when the signal is inputted to the input terminal 10 of the feed circuit 7, the second coupler 3b distributes this signal to the two terminals 3-3 and 3-4 thereof and outputs two signals.

The signal outputted from the terminal 3-4 of the second coupler 3b is inputted to the input terminal 8-2 of the second septum polarizer 8b, and is converted into a right-hand circularly polarized signal by the second septum polarizer 8b and this right-hand circularly polarized signal is outputted from the output terminal 8-3. As a result, the radiating element 2-7 radiates a right-hand circularly polarized beam #7.

The signal outputted from the terminal 3-3 of the second coupler 3b is inputted to the input terminal 8-2 of the first septum polarizer 8a by the third coupler 3c.

The first septum polarizer 8a converts the signal inputted from the third coupler 3c into a right-hand circularly polarized signal, and outputs this right-hand circularly polarized signal from the output terminal 8-3 thereof. As a result, the radiating element 2-6 radiates a right-hand circularly polarized beam #6.

Further, also in feed circuits for supplying electric power to the radiating elements 2-8 to 2-12, right-hand circularly polarized signals are outputted to the radiating elements 2-8 to 2-12 by septum polarizers. As a result, beams #8 to #12 radiated from the radiating elements 2-8 to 2-12 are also right-hand circularly polarized beams.

In this way, the multibeam B including the beams #6 and #7 is right-hand circularly polarized beams.

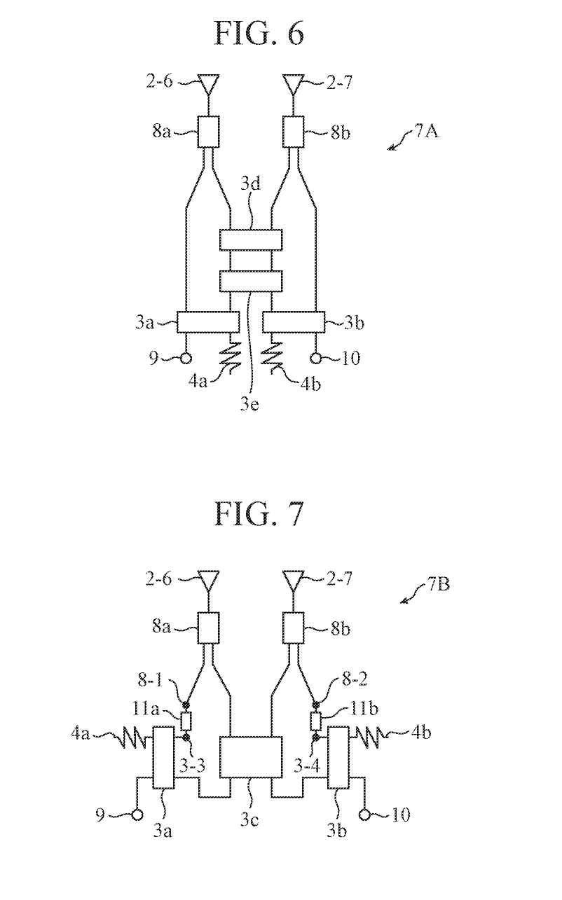

FIG. 6 is a block diagram showing another example of the configuration of the feed circuit according to Embodiment 1, and a feed circuit 7A having a different configuration is described together with the radiating elements 2-6 and 2-7.

The feed circuit 7A has a configuration in which the third coupler 3c shown in FIG. 2A is replaced by 3 dB couplers 3d and 3e connected in series.

A 3 dB coupler distributes a signal inputted to one terminal thereof to two terminals thereof and outputs two signals. The 3 dB coupler receives signals inputted to two terminals thereof and outputs, from one terminal thereof, a signal having power which is the sum of half of the input power at one of the two terminals and half of the input power at the other of the two terminals.

Therefore, the 3 dB couplers 3d and 3e connected in series can operate in the same way as the third coupler 3c. More specifically, the 3 dB coupler 3e distributes a signal outputted from the first coupler 3a to two terminals thereof and outputs two signals to the 3 dB coupler 3d. The 3 dB coupler 3d outputs a signal having power which is the sum of half of the input power at one of the two terminals thereof and half of the input power at the other terminal to the input terminal 8-1 of the second septum polarizer 8b.

Further, the 3 dB coupler 3e distributes a signal outputted from the second coupler 3b to two terminals and outputs two signals to the 3 dB coupler 3d. The 3 dB coupler 3d outputs a signal having power which is the sum of half of the input power at one of the two terminals and half of the input power at the other terminal to the input terminal 8-2 of the first septum polarizer 8a.

Since the detour configuration of the connecting lines connecting the couplers and the septum polarizers becomes unnecessary even with the above configuration, the same advantage as that mentioned above can be provided.

Although in the above explanation the case in which septum polarizers are used as the first and second polarizers is shown, this embodiment is not limited to this example.

More specifically, in the present disclosure, polarizers each of which outputs a circularly polarized wave having a rotation direction which differs in accordance with to which input terminal a signal is inputted can be alternatively used.

As mentioned above, in the feed circuit 7 according to Embodiment 1, the third coupler 3c outputs a signal outputted from the first coupler 3a to the input terminal 8-1 of the second septum polarizer 8b. In addition, a signal outputted from the second coupler 3b is outputted to the input terminal 8-2 of the first septum polarizer 8a. As a result, since the connecting lines connecting the couplers and the polarizers do not cross each other, and it is not necessary to cause one of the connecting lines to detour around the other connecting line, the feed circuit can be implemented with a simple circuit configuration.

Further, it is possible to input a signal to one of the input terminals of each of the septum polarizers, the one being different between when the multibeam A is radiated and when the multibeam B is radiated. Therefore, circularly polarized beams with different rotation directions can be used in a portion in which the multibeams A and B overlap each other.

Further, in the feed circuit 7A according to Embodiment 1, the third coupler 3c may be the 3 dB couplers 3d and 3e connected in series. Even in this case, because the connecting lines connecting the couplers and the septum polarizers do not cross each other, and it is not necessary to provide the connecting lines with a detour configuration, the feed circuit can be implemented with a simple circuit configuration.

In addition, in the feed circuit 7 according to Embodiment 1, the first and second couplers 3a and 3b are 3 dB couplers. Even in this case, since the connecting lines connecting the couplers and the septum polarizers do not cross each other, and it is not necessary to provide the connecting lines with a detour configuration, the feed circuit can be implemented with a simple circuit configuration.

In addition, the antenna apparatus 1 according to Embodiment 1 includes the radiating elements 2-1 to 2-12, and the feed circuit 7 that supplies electric power to the radiating elements 2-6 and 2-7 which are shared between the multibeams A and B. Since the feed circuit 7 can be implemented with a simple circuit configuration, as mentioned above, simplification of the configuration of the antenna apparatus 1 can also be expected as a result.

### Embodiment 2

FIG. 7 is a block diagram showing the configuration of a feed circuit 7B according to Embodiment 2 of the present disclosure, and the feed circuit 7B is described together with radiating elements 2-6 and 2-7. In FIG. 7, the same components as those shown in FIG. 2A are denoted by the same reference signs, and the explanation of the components will be omitted hereafter.

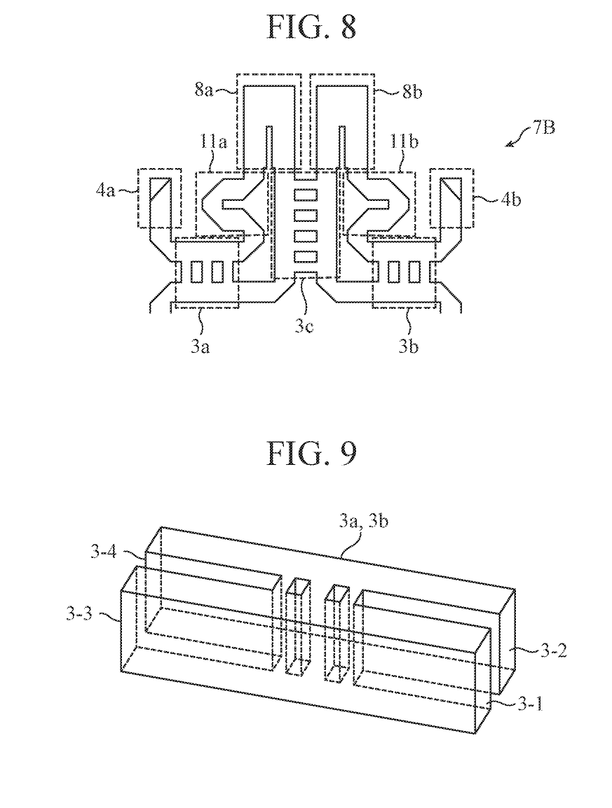

FIG. 8 is a top view showing the configuration of waveguides of the feed circuit 7B. In FIG. 8, the illustration of the radiating elements 2-6 and 2-7 is omitted.

The feed circuit 7B has a configuration in which phase shift circuits 11a and 11b are added to the feed circuit 7 shown in FIG. 2A.

The phase shift circuit 11a is disposed in a path connecting a terminal 3-3 of a first coupler 3a and an input terminal 8-1 of a first septum polarizer 8a, as shown in FIG. 7. The phase shift circuit 11b is disposed in a path connecting a terminal 3-4 of a second coupler 3b and an input terminal 8-2 of a second septum polarizer 8b.

The first coupler 3a, the second coupler 3b, and a third coupler 3c are embodied as branch line couplers. For example, as shown in FIG. 9, each of the first and second couplers 3a and 3b may be a branch line coupler fabricated using waveguides.

In this branch line coupler, terminals 3-1 to 3-4 shown in FIG. 3A are rectangular waveguide terminals. Likewise, the third coupler 3c may be a branch line coupler fabricated using waveguides.

In a case in which the third coupler 3c is constructed from, instead of a 0 dB coupler, two 3 dB couplers connected in series, and the gap shown in FIG. 9 between a waveguide having a terminal 3-3 and a waveguide having a terminal 3-4 is made to be equal for the 0 dB coupler and the 3 dB coupler, a central waveguide connecting these two waveguides in each of the 3 dB couplers can be made to have a wider width than that in the 0 dB coupler. Therefore, in the case in which the third coupler is constructed using 3 dB couplers, there is provided an advantage of increasing resistance to manufacturing errors and making it easy to manufacture the third coupler 3c.

Further, each of the first and second septum polarizers 8a and 8b can also be constructed using a waveguide. For example, in a septum polarizer which is a waveguide shown in FIG. 10, input terminals 8-1 and 8-2 shown in FIG. 5A are rectangular waveguide terminals, and an output terminal 8-3 shown in FIG. 5A is a square waveguide terminal.

In a case in which the feed circuit 7B is constructed using waveguide components, it is necessary to correct the length of a connecting line between components in order to adjust an amount of phase shift of a signal.

Accordingly, in the feed circuit 7B, the phase shift circuits 11a and 11b are disposed in portions in each of which it is necessary to correct the length of the connecting line. The phase shift circuits 11a and 11b are waveguides each of which is bent as shown in FIG. 8, and the length of the connecting line can be properly corrected by this configuration. Since the phase shift amount of a signal is properly adjusted because of this correction, an improvement in the power supply characteristics can be achieved.

Further, the first coupler 3a can be arranged on one side of the third coupler 3c in such a way that the propagating direction of a signal in the first coupler 3a is perpendicular to the propagating direction of a signal in the third coupler 3c, and the second coupler 3b can be arranged on another side of the third coupler 3c in such a way that the propagating direction of a signal in the second coupler 3b is perpendicular to the propagating direction of a signal in the third coupler 3c.

For example, in a case in which the first, second, and third couplers 3a, 3b, and 3c are waveguides, the first coupler 3a is arranged on one side of the third coupler 3c in a state in which the waveguide axial direction which is the propagating direction of a signal in the first coupler 3a is made to be perpendicular to the waveguide axial direction which is the propagating direction of a signal in the third coupler 3c, as shown in FIG. 8. Similarly, the second coupler 3b is arranged on another side of the third coupler 3c in a state in which the waveguide axial direction which is the propagating direction of a signal in the second coupler 3b is made to be perpendicular to the waveguide axial direction of the third coupler 3c.

As a result, since the length from the input terminal 9 to the radiating element 2-6 and the length from the input terminal 10 to the radiating element 2-7 can be shortened, downsizing of the feed circuit 7B can be achieved.

Further, in the case in which the first and second couplers 3a and 3b are arranged in the above-mentioned way, the phase shift circuit 11a can be arranged in an empty space on one side of the third coupler 3c, and the phase shift circuit 11b can be arranged in an empty space on another side of the third coupler 3c, as shown in FIG. 8.

By this, the components can be closely arranged in the spaces on both the sides of the third coupler 3c, and further downsizing of the feed circuit 7B can be achieved.

As explained above, in the feed circuit 7B according to Embodiment 2, the first, second, and third couplers 3a, 3b, and 3c are branch line couplers.

By this, each of the functions of the first, second, and third couplers 3a, 3b, and 3c can be implemented with a simple configuration.

Further, the feed circuit 7B according to Embodiment 2 includes a phase shift circuit in at least one of the connecting lines for making connections among the first coupler 3a, the second coupler 3b, the third coupler 3c, the first septum polarizer 8a, and the second septum polarizers 8b. For example, the phase shift circuit 11a is disposed in the connecting line connecting the first septum polarizer 8a and the first coupler 3a, and the phase shift circuit 11b is disposed in the connecting line connecting the second septum polarizer 8b and the second coupler 3b.

With this configuration, the length of each of the connecting lines is corrected properly and an improvement in the power supply characteristics can be achieved.

In addition, in the feed circuit 7B according to Embodiment 2, the first coupler 3a is arranged on one side of the third coupler 3c in such a way that the propagating direction of a signal is perpendicular to the propagating direction of a signal in the third coupler 3c. The second coupler 3b is arranged on another side of the third coupler 3c in such a way that the propagating direction of a signal is perpendicular to the propagating direction of a signal in the third coupler 3c. With this configuration, downsizing of the feed circuit 7B can be achieved.

The antenna apparatus 1 shown in FIG. 1A can include the feed circuit 7B above.

For example, by disposing the phase shift circuits 11a and 11b, the antenna apparatus 1 with improved power supply characteristics can be obtained.

Further, in the antenna apparatus 1, the first, second, and third couplers 3a, 3b, and 3c can be constructed using waveguide branch line couplers, and the first and second couplers 3a and 3b can be arranged, as shown in FIG. 8. With this configuration, the length from the input terminal of the feed circuit 7B to each of the radiating elements can be shortened and the feed circuit 7B can be downsized, and downsizing of the antenna apparatus 1 can also be achieved because of this downsizing.

### Embodiment 3

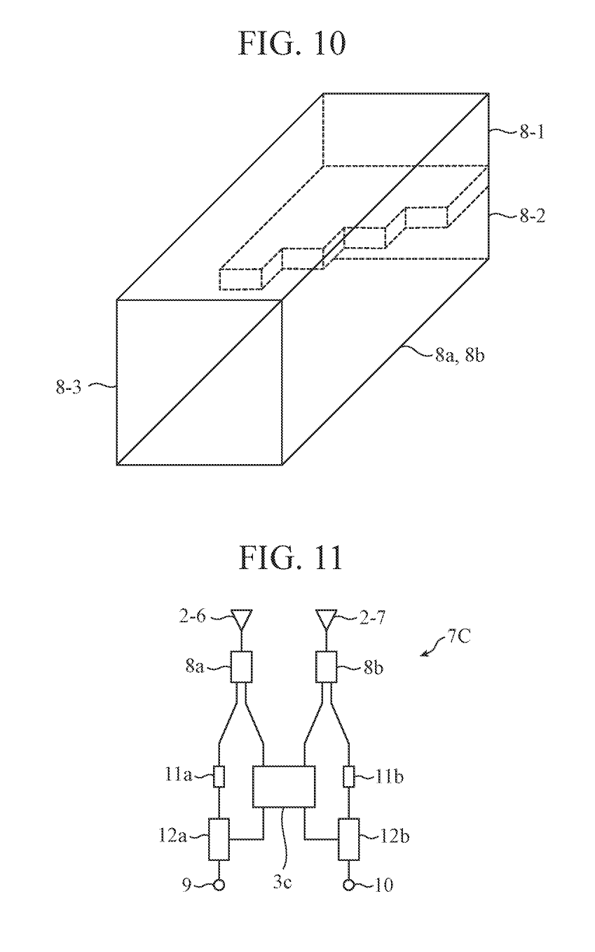

FIG. 11 is a block diagram showing the configuration of a feed circuit 7C according to Embodiment 3 of the present disclosure, and the feed circuit 7C is described together with radiating elements 2-6 and 2-7. In FIG. 11, the same components as those shown in FIGS. 2A and 7 are denoted by the same reference signs, and the explanation of the components will be omitted hereafter.

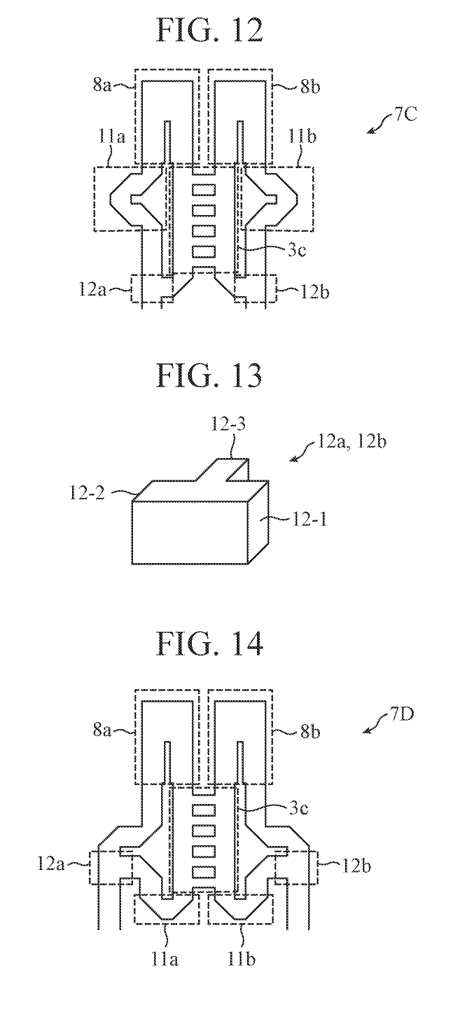

FIG. 12 is a top view showing the configuration of waveguides of the feed circuit 7C. In FIG. 12, the illustration of the radiating elements 2-6 and 2-7 is omitted.

The feed circuit 7C has a configuration in which first and second T-branching circuits 12a and 12b are disposed instead of the first and second couplers 3a and 3b in the feed circuit 7B shown in FIG. 7. The first T-branching circuit 12a and the second T-branching circuit 12b are concrete examples of a first two-way distributor and a second two-way distributor according to the present disclosure, and each of the first and second T-branching circuits distributes a signal inputted to one of three terminals thereof to the two remaining terminals thereof and outputs two signals.

In a case in which the feed circuit 7C is constructed using waveguide components, each of the first and second T-branching circuits 12a and 12b is a waveguide having three terminals 12-1 to 12-3, as shown in FIG. 13. The waveguide shown in FIG. 13 is smaller than that shown in FIG. 9. Therefore, the feed circuit 7C shown in FIG. 12 can be downsized compared with the feed circuit 7B shown in FIG. 8.

Like in the case of a feed circuit 7D shown in FIG. 14, a phase shift circuit 11a can be arranged between the first T-branching circuit 12a and a third coupler 3c, and a phase shift circuit 11b can be arranged between the second T-branching circuit 12b and the third coupler 3c. Even with this configuration, the feed circuit 7D can be downsized compared with the configuration provided with the first and second couplers 3a and 3b.

Further, although the example in which the first and second T-branching circuits 12a and 12b are disposed instead of the first and second couplers 3a and 3b in the feed circuit 7B shown in FIG. 7 is shown, this embodiment is not limited to this example. For example, the first and second T-branching circuits 12a and 12b can be disposed instead of the first and second couplers 3a and 3b in either the feed circuit 7 shown in FIG. 2A or the feed circuit 7A shown in FIG. 6.

As described above, in the feed circuit 7C or 7D according to Embodiment 3, the first two-way distributor is the first T-branching circuit 12a and the second two-way distributor is the second T-branching circuit 12b. With this configuration, the feed circuit 7C or 7D can be downsized.

Further, the antenna apparatus 1 shown in FIG. 1A can include the feed circuit 7C or 7D above. For example, by disposing the first and second T-branching circuits 12a and 12b instead of the first and second couplers 3a and 3b, the feed circuit 7C or 7D can be downsized and downsizing of the antenna apparatus 1 can also be achieved because of this downsizing.

Although in Embodiments 1 to 3 the case in which by using the first and second septum polarizers 8a and 8b, circularly polarized beams with different rotation directions are used in a portion in which multibeams overlap each other is shown, the concept disclosed in the present disclosure can also be applied to linearly polarized beams.

For example, a four-terminal circuit which is called a magic T, and which inputs signals having either the same phase and the same amplitude or opposite phases and the same amplitude to the two input terminals of each of the first and second septum polarizers 8a and 8b is used. A magic T can output a signal inputted to one of two input terminals thereof from two output terminals thereof, with the same phase and the same amplitude, and output a signal inputted to the other input terminal thereof from the two output terminals thereof, with opposite phases and the same amplitude. By using this magic T, the output signal of each of the septum polarizers can be switched between a vertically linearly polarized signal and a horizontally linearly polarized signal, and the concept disclosed in this disclosure can also be applied to linearly polarized signals.

It should be understood that any combination of two or more of the above-described embodiments can be made, various modifications can be made to any components according to the above-described embodiments, and any component according to the above-described embodiments can be omitted, within the scope of the invention.

### INDUSTRIAL APPLICABILITY

Since the feed circuit according to the present disclosure can use circularly polarized beams with different rotation directions in a portion in which multibeams overlap each other, with a simple circuit configuration, the feed circuit is suitable for use as a feed circuit for multibeam antennas which are mounted in, for example, space equipment such as an artificial satellite or a spacecraft.

### REFERENCE SIGNS LIST

1 antenna apparatus; 2-1 to 2-12 radiating element; 3 coupler; 3-1 to 3-4, 3c-1 to 3c-4, and 12-1 to 12-3 terminal; 3a first coupler; 3b second coupler; 3c third coupler; 3d and 3e 3 dB coupler; 4, 4a, and 4b terminator; 5, 6, 8-1, 8-2, 9, and 10 input terminal; 7, 7A to 7D, and 100 feed circuit; 8-3 output terminal; 8a first septum polarizer; 8b second septum polarizer; 11a and 11b phase shift circuit; 12a first T-branching circuit; 12b second T-branching circuit; and 101 crossing.

1. A feed circuit comprising:
first and second polarizers each having an output terminal and two input terminals, each for outputting, from the output terminal thereof, a signal having polarization whose direction differs between when a signal is inputted to one of the two input terminals thereof and when a signal is inputted to another one of the two input terminals thereof;
a first two-way distributor having two terminals via each of which a signal is inputted or outputted, one of the two terminals thereof being connected to the one of the input terminals of the first polarizer, for distributing an input signal to the two terminals thereof and outputting two signals;
a second two-way distributor having two terminals via each of which a signal is inputted or outputted, one of the two terminals thereof being connected to the other one of the input terminals of the second polarizer, for distributing an input signal to the two terminals thereof and outputting two signals; and
a third coupler for outputting a signal outputted from another one of the two terminals of the first two-way distributor to the one of the input terminals of the second polarizer, and for outputting a signal outputted from another one of the two terminals of the second two-way distributor to the other one of the input terminals of the first polarizer,
wherein the first two-way distributor is arranged on one side of the third coupler in such a way that a waveguide axial direction of the first two-way distributor which is a propagating direction of a signal is perpendicular to a waveguide axial direction which is a propagating direction of a signal in the third coupler, and the second two-way distributor is arranged on another side of the third coupler in such a way that a waveguide axial direction of the second two-way distributor which is a propagating direction of a signal is perpendicular to a waveguide axial direction which is a propagating direction of a signal in the third coupler.

2. The feed circuit according to claim 1, wherein each of the first and second polarizers outputs, from the output terminal thereof, a circularly polarized signal with a rotation direction which differs between when a signal is inputted to the one of the two input terminals thereof and when a signal is inputted to the other one of the two input terminals thereof.

3. The feed circuit according to claim 1, wherein the third coupler is two 3 dB couplers connected in series.

4. The feed circuit according to claim 1, wherein the first two-way distributor and the second two-way distributor are 3 dB couplers.

5. The feed circuit according to claim 1, wherein the first two-way distributor, the second two-way distributor, and the third coupler are branch line couplers.

6. The feed circuit according to claim 1, wherein a phase shift circuit is disposed in at least one of connecting lines for making connections among the first two-way distributor, the second two-way distributor, the third coupler, the first polarizer, and the second polarizer.

7. (canceled)

8. The feed circuit according to claim 1, wherein the first two-way distributor and the second two-way distributor are T-branching circuits.

9. An antenna apparatus comprising:
plural radiating elements each for radiating a beam; and
the feed circuit according to claim 1,
wherein each output terminal of the first and second polarizers is connected to a radiating element for radiating a beam at a portion in which adjacent multibeams, among plural multibeams formed by plural beams radiated by the plural radiating elements, overlap each other.
